(19) United States
(12) Patent Application Publication
(10) Pub. No.: US 2009/0272281 A1
(43) Pub. Date: Nov. 5, 2009

(54) Slicing and dicing device

(76) Inventors: Lance Hood, Seattle, WA (US); Joshua R. Stewart, Seattle, WA (US)

Correspondence Address: JOHN R. BENEFIEL, 525 Lewis Street, BIRMINGHAM, MI, 48009, US

(21) Appl. No.: 12/290,114

(22) Filed: Oct. 27, 2008

Related U.S. Application Data
(60) Provisional application No. 61/000,504, filed on Oct. 26, 2007.

(51) Int. Cl. A47J 43/04; B26D 7/06

(52) U.S. Cl. 99/538; 83/437.5; 83/437.6; 83/435.19

(57) ABSTRACT

A slicing and dicing device which includes a pivoted lever which when stroked slides a pusher assembly partway along on a main body towards a cutter piece to slice an interposed item. Gearing operated by the lever disengages after each stroke to allow another stroke, reducing the peak effect required by limiting the range of motion to a range where good leverage is obtained. A dicing assembly is mounted forward of the cutter piece for vertical sliding motion to allow cross cutting of strips sliced out of the item by the cutter piece.

### CROSS REFERENCE TO RELATED APPLICATIONS

This application claims the benefit of U.S. provisional application No. 61/000,504 filed on Oct. 26, 2007.

### BACKGROUND OF THE INVENTION

This invention concerns slicing of vegetables or fruits such as potatoes into strips (i.e., french fries) or diced into cubes. There has heretofore been provided “potato chippers” which operate to force a potato (or other fruit or vegetable) through a cutter grid to slice the same into strips such as create french fries from a whole potato.

A lever is manually pivoted through a single stroke which causes the item to be advanced by engagement of a pusher face having a pattern of plugs which fit into the cutter grid when the pusher face is fully advanced.

Since a large number of slicing cuts into the item are made simultaneously, a substantial effort is required. The lever typically pivots through a range of 90° from a fully upright position, and the leverage able to be exerted by the user varies depending on the angle of the lever and a greater effort is required at the beginning of the lever motion when the lever is fully upright.

Long levers are sometimes employed to reduce the effort, but this results in too bulky device for the home kitchen where space is at a premium and increases the cost of the device.

While some versatility has been added to such devices by replaceable cutter grids of differing size, it would be advantageous if additional cutting functions could be provided by such device.

It is the object of the present invention to provide a fruit or vegetable slicer device of the type described in which the peak effort required to be exerted on an operating lever is reduced while maintaining a compact size.

It is a further object to provide such a device which also is capable of carrying out a dicing feature as well as conventional slicing.

### SUMMARY OF THE INVENTION

The above recited objects as well as other objects which will become apparent to those knowledgeable in the art upon a reading of the follow specification and claims are achieved by a slicer having a pivoted operating lever which rotates gearing to cause a carriage to be advanced along a main body forcing an item to be pushed along the main body which has a cutter grid at a far end and through which the item is forced by repeated pivoting of the lever through a relatively narrow angular range.

The gearing includes sector gears attached to the lever and intermediate pinion gears rotatably mounted on the carriage and held in engagement with gear racks fixed extending lengthwise along the main body to the cutter grid.

The lever sector gears are disengageable with the intermediate pinion gearing by elongated holes pivotally mounting the lever to the carriage. Wire form springs engage the lever to normally urge the lever to an elevated position in which the lever pin pivot mount moves to the top of the elongated holes, with the sector gears then becoming separated from the intermediate pinion gearing Upon pushing down on the lever, the lever pivot pins descend in the elongated holes, and the sector gears engage the pinion gearing.

The lever is pivoted down from an angled position to advance the carriage a part of the way towards the cutter grid, with an item to be sliced partially advanced into the cutter grid.

Upon releasing pressure on the lever it pivots back up and the sector gears disengage from the pinion gearing and another stroking then carried out, with this repeated until the item is fully advanced through the cutter grid to be completely sliced up.

A vertically oriented dicer blade and holder assembly maybe slidably mounted just forward of the cutter grid to be raised prior to each over operation and lowered to cross cut each length of the strips emerging from the cuter grid after a lever stroke and create diced portions thereof.

### DESCRIPTION OF THE DRAWING FIGURES

FIG. 1 is a reduced size pictorial view of a slicer and dicer device according to the invention.

FIG. 2 is a plane view of the slicer and dicer shown in FIG. 1.

FIG. 3 is a pictorial exploded view of the components of the slicer and dicer shown in FIG. 1.

FIG. 3A is an enlarged pictorial view of a lever spring shown in FIG. 3.

FIG. 3B is an enlarged pictorial view of inner pinion gear set shown in FIG. 3.

FIG. 3C is an enlarged pictorial view of one of the out pinion gears shown in FIG. 3.

FIG. 3D is an enlarged view of one of the outer sector gears shown in FIG. 3.

FIG. 4 is an enlarged view of the section 4-4 taken in FIG. 2.

FIG. 5 is a pictorial view of a pusher assembly included in the device shown in FIG. 1.

FIG. 6 is a pictorial view of a carriage included in the pusher assembly shown in FIG. 5.

FIG. 6A is a sectional view of the carriage shown in FIG. 6.

FIG. 7 is a pictorial view of a main body included in the device shown in FIGS. 1 and 2.

FIG. 8 is a pictorial reverse view of a large sizepusher face shown in FIG. 3.

FIG. 9 is a pictorial view of a dicer blade assembly included in the device shown in FIG. 1.

FIG. 10 is a fragmentary view of the section shown in FIG. 4 with the pusher assembly retracted in preparation for a slicing stroke with the sector and pinion gearing disengaged.

FIG. 11 is a view of the section shown in FIG. 4 with an item I in position and the lever pushed down to engage the pusher gearing.

FIG. 12 is a fragmentary view of the section shown in FIG. 4 at the end of a lever stroke.

FIG. 13 is pictorial view of the device, shown in FIG. 1 with the lever raised and the dicer blade assembly also raised in preparation for a slice and dice operation.

FIG. 14 is a pictorial view of the device shown in FIG. 13 at the completion of a slice and dice operation.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to the drawings and particularly claims 1 and 2, a slicing and dicing device 10 in a stored condition according to the invention. The device 10 includes a main body 12 supported on feet 14.

A cutting grid 16 is supported at an upright front end 17 of the main body with plugs of a pusher face 24 of a pusher assembly 18 protruding through spaces in the cutter grid 16.

The main body 12 includes a pusher assembly 18 supported on a bed 20 defined by the main body 12 to the rear of the front end 17.

FIG. 1 show the pusher assembly 18 in its storage condition.

A dicer blade assembly 22 is received in the front end 17 of the main body 12 to be vertically slidable therein as well be described herein.

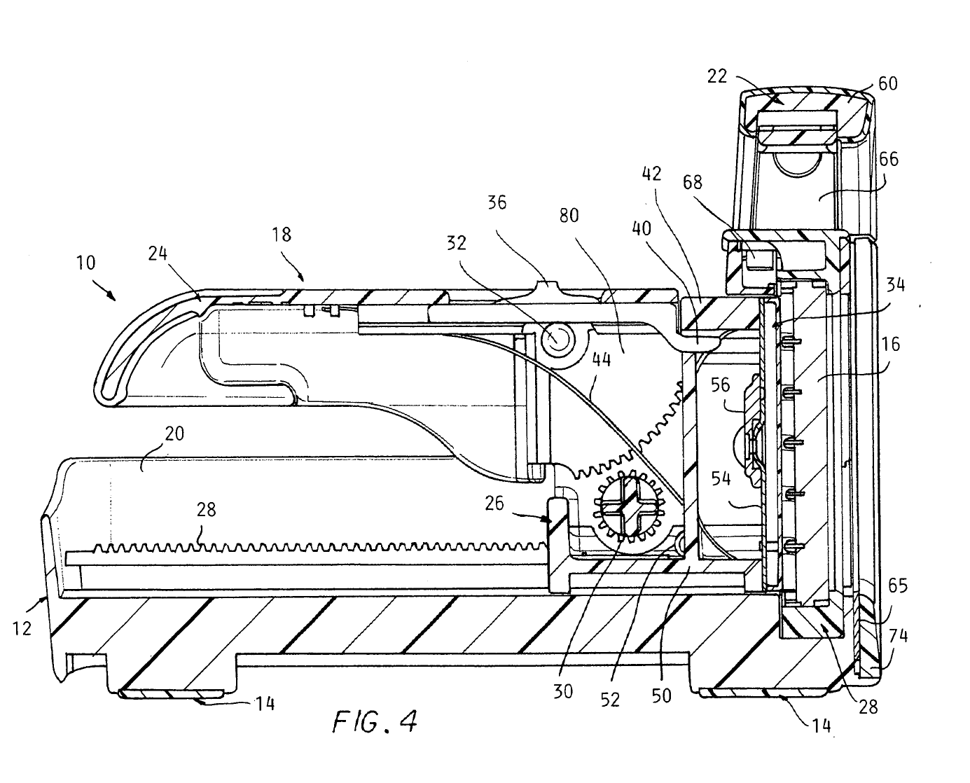

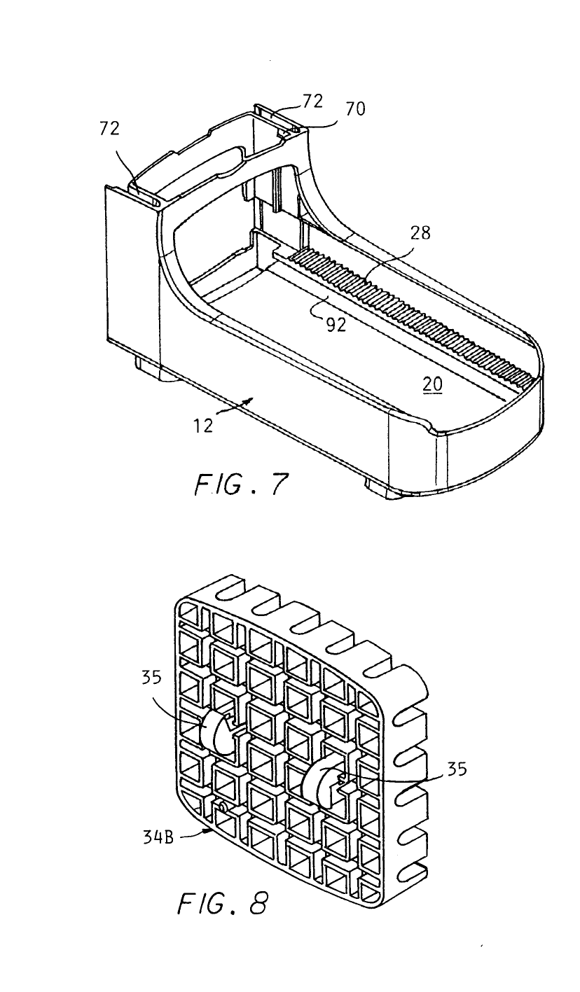

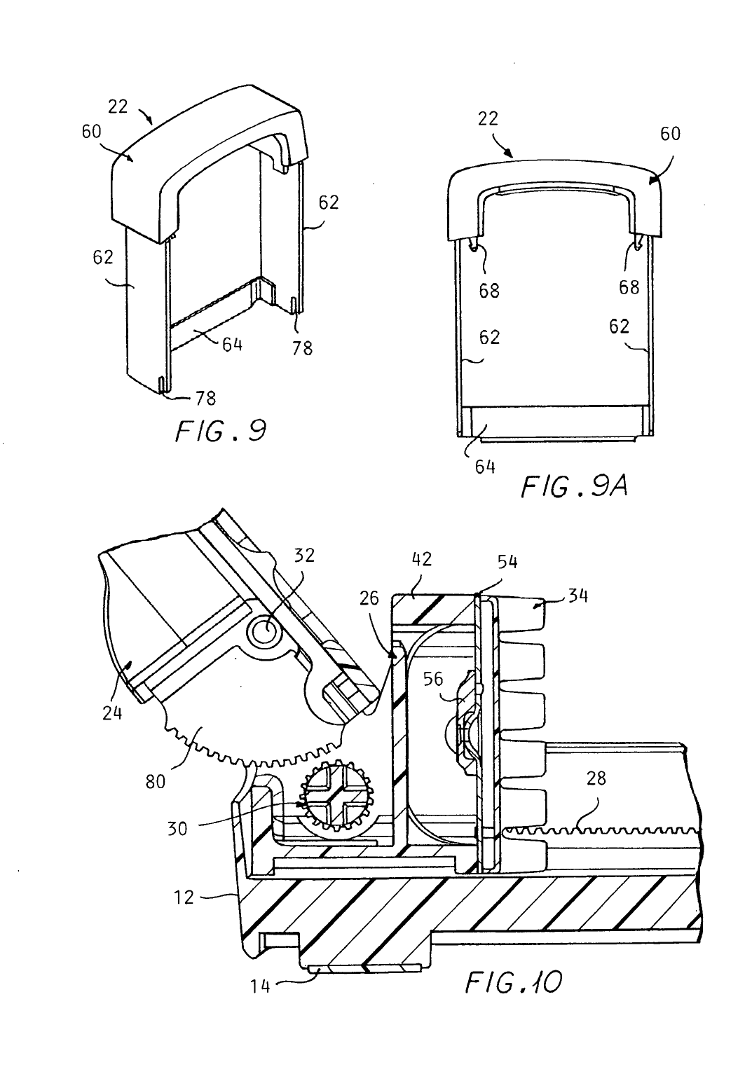

FIG. 4 shows an enlarged sectional view of the slicing and dicing device 10 in the storage condition.

The pusher assembly 18 includes a short lever 24 pivotally mounted to a molded plastic carriage 26 movable along main body bed 30 engaged by pinion gear assembly 30. The lever 24 may be molded of ABS plastic with a softer overmold of TPE plastic.

The lever 24 is pivotally mounted at one end to ears spaced apart of the carriage 26 by press pins 32.

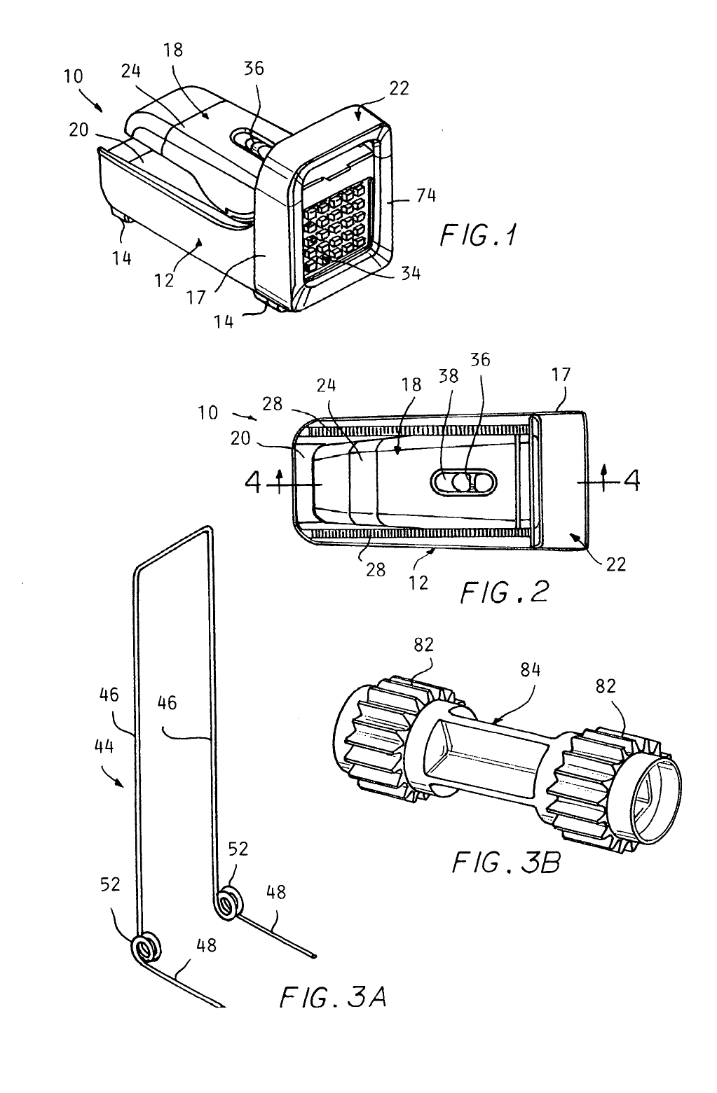

A lever lock slide 36 accessible through a slot 38 in the lever 24 is slidable to the front along the slot 38 where a catch lip 40 enters a slot 43 in a top wall 42 of the carriage 26 to hold the lever 24 in its lowered position shown in FIGS. 1, 2, and 4.

A wire form spring piece 44 has a pair of long legs 46 extending beneath the lever 24 and a pair of short legs 48 resting on a bottom wall 50, with intermediate wound up coils 52 creating a spring pressure resisting downward pivoting of the lever 24 and urging it back up when depressed, as seen in FIG. 4.

A stainless steel mounting plate 54 is attached to a front end of the carriage 26 with screws 55. A pivotable push face lock 56 riveted to the plate 54 holds either one of two pusher face blocks 34A or 34B to the plate 54 and the front end of the carriage 26 by engagement with a pair of oppositely oriented hooks 35 on each pusher face block 34A and 34B (FIG. 8). The plug pattern of the pusher face blocks 34A, 34B configured are to enter grid spaces in a cutter grid 16A or 16B alternatively installed in a blade cartridge frame 58 upon fully advancing the pusher assembly 18.

The dicer blade assembly 22 includes an upper handle 60 (which may have an overmold as indicated) having attached a pair of stainless steel blade supports 62 and a U-shaped blade 64 welded to the supports 62, having a sharpened portion 65 extending between the supports.

A lock piece 66 beneath the handle 60 has locking catch portions 68 engaging features 70 on the front end of the main body 12 when the dicer blade assembly 22 is fully lowered. In this position, the blade sharpened edge portion 65 lies below the cutter grid 16A or 16B to not interfere with slicing of the item. The blade 64 is slidable in a space to the rear a facia piece 74 and the main body front end 17 while the supports 62 are slidable in spaces 72 (FIG. 7).

A pair of helical compression springs 76 in spaces 72 are engaged with notches 78 to spring load the dicer blade assembly 22 and urge it to its raised position.

The lever 24 has a pair of sector gears 80 held to a respective side wall portion, each sector gear 80 aligned with a respective one of a pair of inner pinion gears 82 formed at either end of a gear tube 84 of the pinion gear assembly 30.

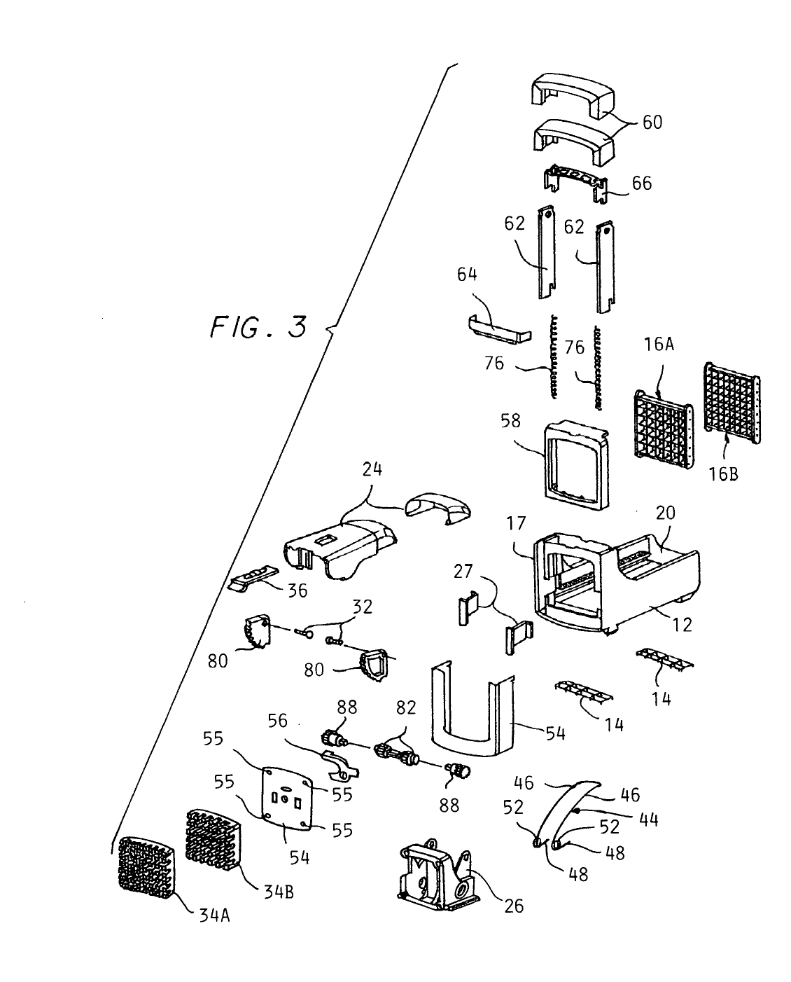

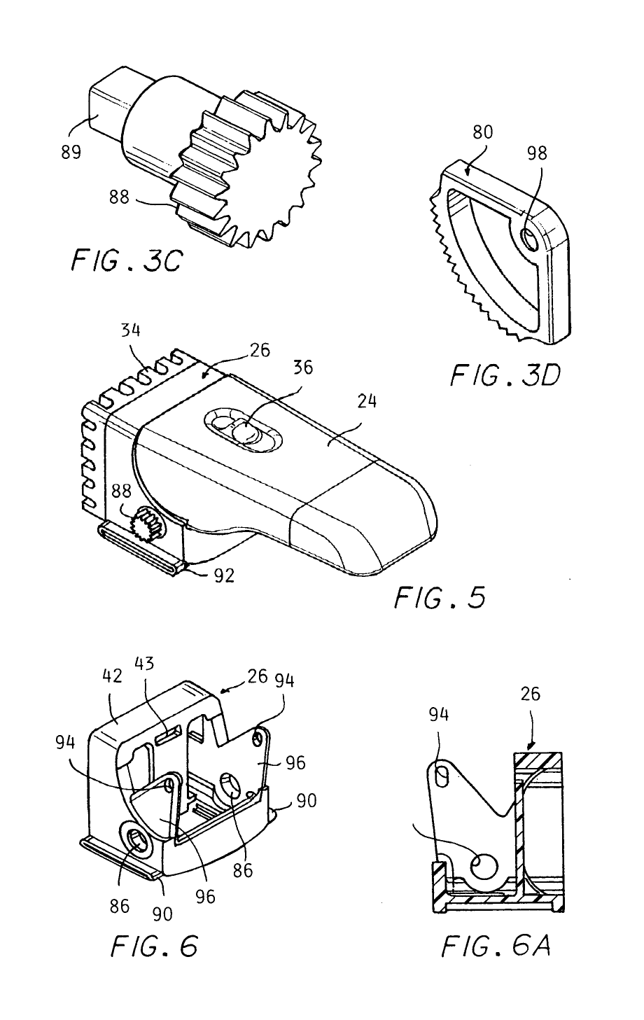

The pinion gear tube 84 is rotatably mounted in the carriage 26 received in holes 86 (FIGS. 6, 6A) and captured by outer pinion gears 88 press fit into respective ends of the gear tube 84 with square shapes 89 preventing relative rotation (FIGS. 3B, 3C). The outer pinions 88 are each meshed with a respective gear rack 28.

The carriage 26 is captured by protrusions 90 riding in a guideway space 92 beneath gear racks 28.

Stop inserts 27 are ultrasonically welded with the front of the main body 12 after the carriage 26 is assembled thereto, preventing advance out of the main body 1 after assembly.

The lever 24 is pivotally mounted to the carriage 26 by a pair of pins 32 passed through elongated holes 94 in spaced ears 96 on the carriage 26. The pins 32 are each pressed into a respective hole 98 in each sector gear 80 press fit inside the lever 24.

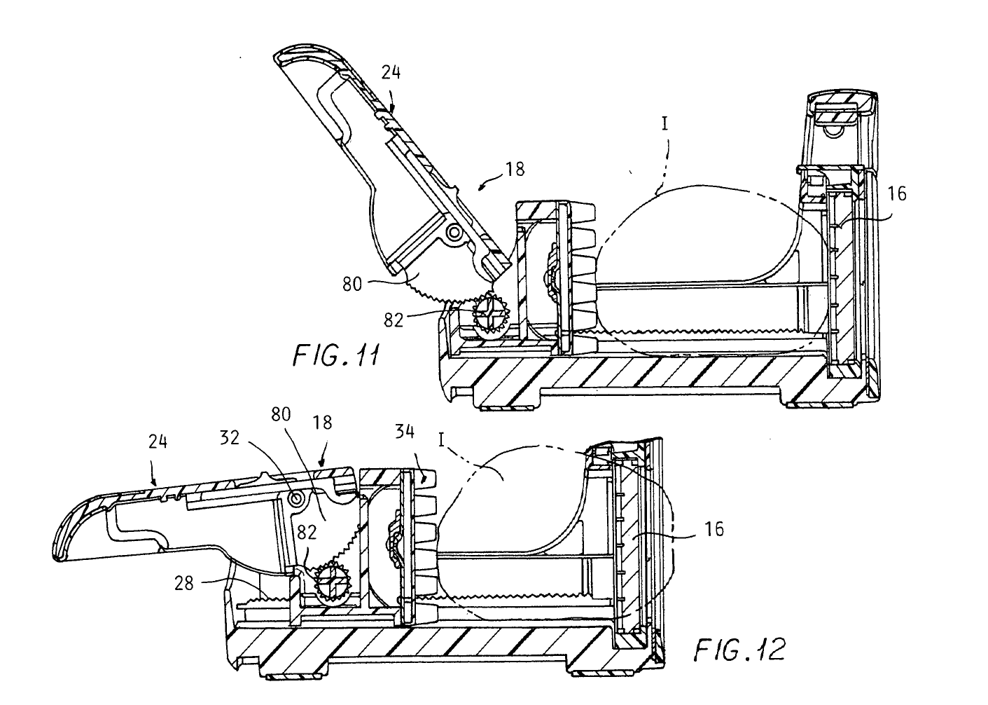

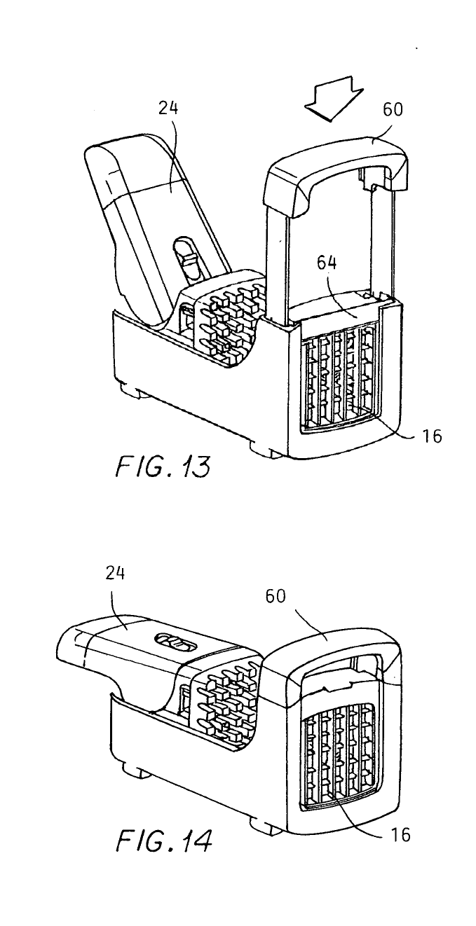

The spring 44 urges the lever 24 upwardly such that pins 32 are normally pushed to the top of elongated holes 94 which allow limited vertical travel of the lever 24, i.e. on the order of 3.5 mm travel. In this condition, shown in FIG. 10, the sector gears 80 are out of engagement with pinion gears 82. The lever 24 is positioned at an inclined angle as shown.

Upon exertion of downward pressure on the lever 24, the sector gears 80 are brought into mesh with pinion gears 82 as seen in FIG. 11.

Continued downward movement of the lever 24 causes the pusher assembly 18 to advance as seen in FIG. 12 by the pinions 88B rotating while engaged with the gear racks 28. This causes the pusher face 34 to advance the item I partially through the cutter grid 16 and cut strips therein.

The item I is only partially sliced such that several strokes of the lever 24 are required to complete the cutting. The disengagement of gears 80, 82 allows the successive stroking of the lever while slicing a single item I.

The stroke of lever 24 is limited to be entirely within a range where good leverage is developed, thus reducing the peak effort required. An inclined start position, i.e., 70°, rather than a straight up position reduces the peak effort required.

To also dice, the handle 60 is pulled up, the lock 66 released thereby. The lever 24 is then pivoted down to partially advance and partially slice an item I.

The handle 60 is then depressed to cross cut the partially sliced strips to dice the item.

This is repeated until the item I is completely cut up.

1. A slicer device comprising:
a pusher assembly slidable along the main body;
a lever pivotally mounted to the pusher assembly;
gearing causing said pusher assembly to advance along said main body upon pivot stroking of said lever;
a cutter piece mounted on an upward extending portion of said main body aligned with said pusher assembly to slice an item interposed between said pusher assembly and said cutter, pushed into said cutter by advance of said pusher assembly;
said gearing disengaged upon release of said lever and reengaged upon exerting downward pressure on said lever to allow successive strokes of said lever with a limited range of lever pivot motion wherein good leverage can be exerted therein by a user to cut an item.

2. The slicer device according to claim 1 wherein said gearing includes one or more gear racks extending along said main body and engaged by pinion gearing rotated by stroking of said lever.

3. The slicer device according to claim 2 wherein said lever has gearing rotated therewith engageable with said pinion gearing upon exerting pressure on said lever but disengaged by movement of pins extending through elongated holes in a carriage included in said pusher assembly to which said lever is pivotally mounted by said pins, with a spring exerting a disengaging force on said lever opposing said force exerted on said force on said lever to stroke the same.

4. The slicer according to claim 1 further including a dicer blade vertically movable on said main body just forward of said cutter to enable cross cutting of said sliced item to dice the same.

5. The slicer according to claim 1 wherein said lever assumes an inclined start position prior to stroking less than fully upright to thereby reduce the peak effort required.
